(19) United States
(12) Patent Application Publication
(10) Pub. No.: US 2007/0285197 A1
(43) Pub. Date: Dec. 13, 2007

(54) METHOD FOR DISASSEMBLING A MAGNETIC FIELD GENERATOR

(75) Inventors: Shaohui Shi, Wuxi (CN); Hongliang Lu, Shanghai (CN); Weijun Shen, Florence, SC (US); Hai Yu, Shanghai (CN)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/423,000

(22) Filed: Jun. 8, 2006

(51) Int. Cl. H01F 3/00

(52) U.S. Cl. 335/296

(57) ABSTRACT

A method for disassembling a permanent magnet of a magnetic field generator where the permanent magnet has a plurality of magnetic blocks having a layout, includes pushing at least one non-magnetic spacer into the layout of the plurality of magnetic blocks. At least one magnetic block is displaced with the at least one non-magnetic spacer until the at least one magnetic block is pushed out of the layout of the plurality of magnetic blocks. When the at least one magnetic block is pushed out of the layout, the magnetic block is removed from the magnetic field generator. The steps of displacing and removing may be repeated until all of the magnetic blocks in the permanent magnet are replaced with a non-magnetic spacer. The magnetic blocks removed from the magnetic field generator may be demagnetized using known methods.

### FIELD OF THE INVENTION

The present invention relates generally to magnetic field generators for magnetic resonance imaging systems and in particular to a method for disassembling a permanent magnet of a magnetic field generator in an magnetic resonance imaging system.

### BACKGROUND OF THE INVENTION

A magnetic field generator for a magnetic resonance imaging (MRI) system may use permanent magnets to generate a uniform magnetic field. A permanent magnet may be formed using a plurality of magnetic blocks. Permanent magnet MRI systems may be used in various facilities, such as a hospital, clinic, etc., and have a certain lifespan after which they are no longer used. It may be desirable to dismantle a permanent magnet MRI system that is no longer in use. There are, however, many difficulties presented by dismantling a permanent magnet MRI system, in particular, with dismantling the magnetic field generator of a permanent magnet MRI system.

The size of a permanent magnet MRI system can make it difficult to disassemble. Typically, a permanent magnet MRI system is large and heavy, for example, a 0.35 T magnet may weigh more than 17 tons and a 0.2 T magnet may weigh more than 9 tons. In addition, another challenge is presented by the strong magnetic fields generated by magnetic blocks in the permanent magnet of the MRI system. The magnetic field generated by the magnetic blocks in a permanent magnet may be very strong, typically 2000-3500 Gs. These characteristics of a permanent magnet MRI system, in particular, the strong magnetic field of the permanent magnet, make disassembling of a permanent magnet MRI system difficult and present safety concerns.

It would be desirable to provide a safe and low cost method for disassembling a magnetic field generator in a permanent magnet MRI system. In particular, it would be desirable to provide a method for disassembling a permanent magnet, including removing magnetic blocks of the permanent magnet, in a magnetic field generator.

### SUMMARY OF THE INVENTION

In accordance with an embodiment, a method for disassembling a permanent magnet of a magnetic field generator where the permanent magnet is comprised of a plurality of magnetic blocks having a layout, includes pushing at least one non-magnetic spacer into the layout of the plurality of magnetic blocks, displacing at least one magnetic block with the at least one non-magnetic spacer until the at least one magnetic block is pushed out of the layout of the plurality of magnetic blocks, and when the at least one magnetic block is pushed out of the layout, removing the magnetic block from the magnetic field generator.

In accordance with another embodiment, a method for disassembling a magnetic field generator comprising a first yoke plate, a first permanent magnet comprised of a plurality of magnetic blocks having a layout and positioned on the yoke plate and a first pole face positioned on the first permanent magnet, includes lifting the first pole face away from the first permanent magnet to create a gap between the first pole face and the first permanent magnet, pushing at least one non-magnetic spacer into the layout of the plurality of magnetic blocks, displacing at least one magnetic block with the at least one non-magnetic spacer until the at least one magnetic block is pushed out of the layout of the plurality of magnetic blocks, and when the at least one magnetic block is pushed out of the layout, removing the magnetic block from the magnetic field generator.

### DESCRIPTION OF THE DRAWINGS

The invention will become more fully understood from the following detailed description, taken in conjunction with the accompanying drawings, wherein like reference numerals refer to like parts, in which:

FIG. 1a is a schematic diagram of a side view of a magnetic field generator in accordance with an exemplary embodiment.

FIG. 1b is a perspective cutaway view of a magnetic field generator in accordance with an exemplary embodiment.

FIG. 2 is a schematic diagram of an exemplary layout of magnetic blocks in a permanent magnet in accordance with an embodiment.

FIG. 3 is a diagram of an exemplary magnetic block for a permanent magnet in accordance with an embodiment.

FIG. 4 is a schematic diagram illustrating use of a pole face positioning tool in dismantling a magnetic field generator in accordance with an embodiment.

FIG. 5a is a side view of an exemplary magnetic block pusher tool in accordance with an embodiment.

FIG. 5b is a top view of an exemplary magnetic block pusher tool in accordance with an embodiment.

FIG. 6a is a schematic diagram illustrating dismantling of a permanent magnet in accordance with an embodiment.

FIG. 6b is a cross-sectional view of a magnet block pusher head and magnet block along line A-A of FIG. 6a in accordance with an embodiment.

### DETAILED DESCRIPTION

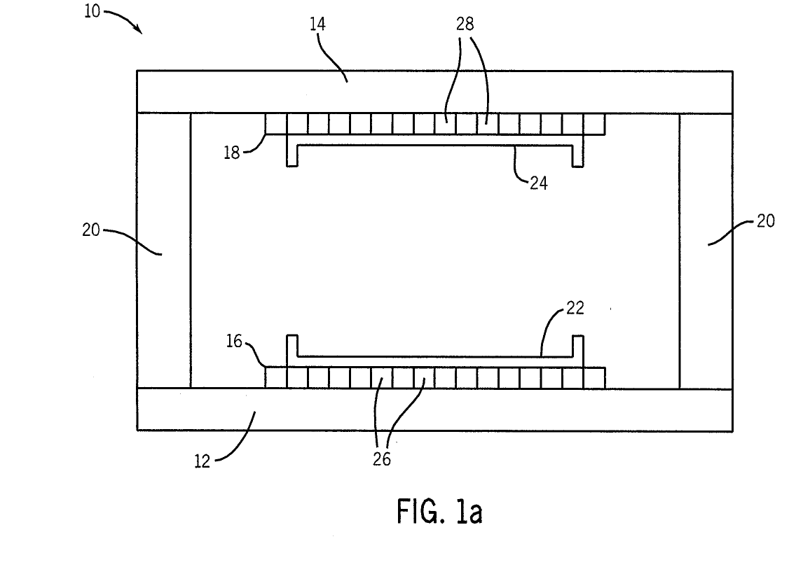

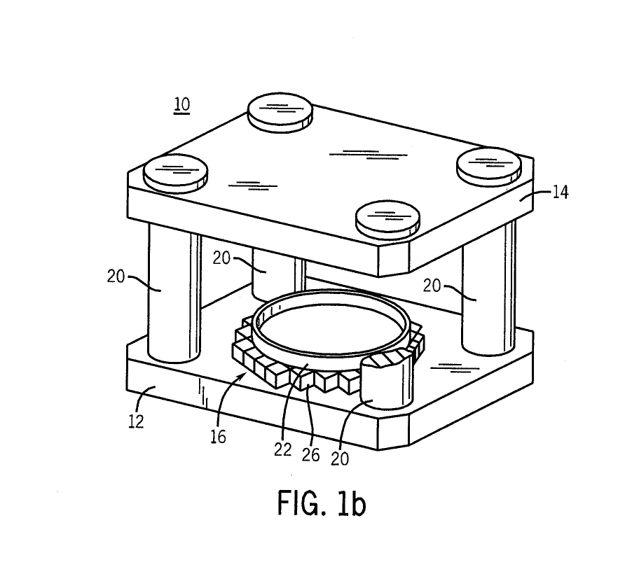

FIG. 1a is a schematic diagram of a side view of a magnetic field generator in accordance with an exemplary embodiment. A magnetic field generator 10 may be utilized in, for example, a magnetic resonance imaging (MRI) system to generate a uniform magnetic field. Magnetic field generator 10 includes a pair of yoke plates, namely, a first yoke plate 12 and a second yoke plate 14 that are opposed to each other. First yoke plate 12 and second yoke plate 14 are supported by and magnetically connected to one or more posts 20 such that there is a space in between the first yoke plate 12 and the second yoke plate 14. Each of the yoke plates 12, 14 has a surface opposed to the other yoke plate. A first permanent magnet 16 is provided on a surface of the first yoke plate 12 and a second permanent magnet 18 is provided on a surface of the second yoke plate 14. Magnetic field generator 10 also includes a pair of pole faces. A first pole face 22 is placed on the permanent magnet 16 and a second pole face 24 is placed on permanent magnet 18. The first permanent magnet 16 on yoke plate 12 and the second permanent magnet 18 on yoke plate 14 are faced to each other so that different magnetic poles are opposed to each other. Accordingly, the magnetic field generator 10 is configured to form a uniform magnetic field in a space between the pair of pole faces 22, 24.

FIG. 1b is a perspective cutaway view of a magnetic field generator in accordance with an exemplary embodiment. As discussed above, magnetic field generator 10 includes a first yoke plate 12 and a second yoke plate 14 coupled to one or more posts 20. On each yoke plate, for example, yoke plate 12, a permanent magnet 16 is placed on a surface that opposes the other yoke plate. A pole face 22 is placed on permanent magnet 16.

Returning to FIG. 1a, each of the permanent magnets 16, 18 includes a plurality of magnetic blocks 26, 28, respectively. The magnetic blocks 26, 28 may be a magnet made from a ternary system compound Nd—Fe—B that is composed mainly of neodynium (Nd), iron (Fe) and boron (B). Alternatively, part of the neodynium of the Nd—Fe—B compound may be replaced by dysprosium (Dy) while part of the iron may be replaced by cobalt (Co). The Nd—Fe—B compound is known as a strong neodynium magnetic material with a maximum energy product of over 300 kj/m³. Other magnets, magnetic material and method of making magnets known in the art may be used.

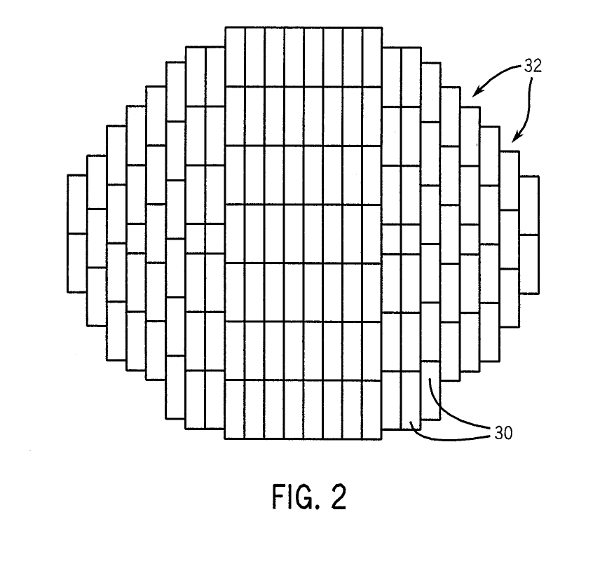

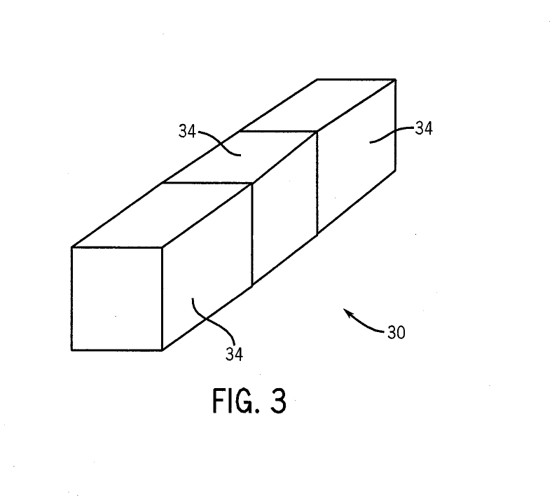

Magnetic blocks 26 are arranges in a layout on plate yoke 12 with a magnetic pole facing upward. Magnetic blocks 28 are arranged in a layout on plate yoke 14 with a magnetic pole facing downward. FIG. 2 is a schematic diagram of an exemplary layout of magnetic blocks in a permanent magnet in accordance with an embodiment. It should be understood that other layouts or arrangements of rows of magnetic blocks may be used for a permanent magnet. In the exemplary embodiment shown in FIG. 2, magnetic blocks 30 are arranged in rows 32 on a yoke plate (not shown). Each row 32 includes a plurality of magnetic blocks 30. The magnetic blocks 30 may be held in place in a row by, for example, block retainers (not shown) positioned at each end of the row 32 of magnetic blocks 30. In a preferred embodiment, the magnetic blocks 30 in each row 32 are not adhered to each other. Each magnetic block 30, however, may include a plurality of magnet members 34 adhered together as shown in FIG. 3. In FIG. 3, multiple magnetic members 34 are adhered to each other with an adhesive, such as an epoxy adhesive, to form the magnetic block 30. For example, the magnetic members 34 may be glued (or adhered) to each other at a side surface in a row direction.

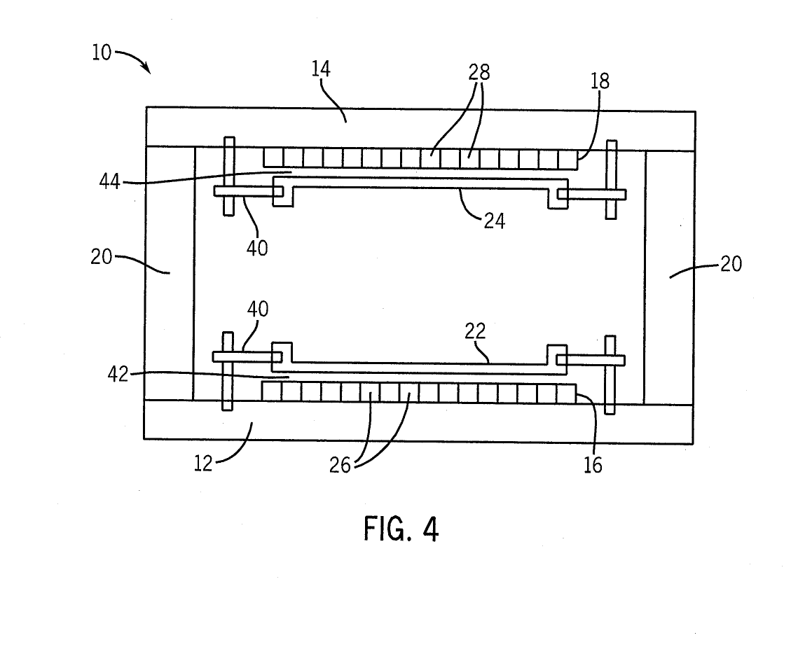

A method of disassembling a magnetic field generator will now be discussed with respect to FIGS. 4, 5a, 5b, 6a and 6b. Referring now to FIG. 4, a pole face positioning tool 40 is used to lift the pole faces 22, 24 from each of the permanent magnets 16, 18, respectively, in the magnetic field generator 10. The pole face positioning tool 40 is mounted to first yoke plate 12 and second yoke plate 14. Pole face positioning tool 40 is also coupled to the pole faces 22, 24 so that the pole faces 22, 24 may be lifted away from the permanent magnets 16, 18, respectively. When first pole face 22 is lifted from the permanent magnet 16, an axial gap 42 is created between pole face 22 and permanent magnet 16. In a similar manner, pole face positioning tool 40 is used to lift second pole face 22 from permanent magnet 18 and establish an axial gap 44 between the pole face 24 and permanent magnet 18. Pole face positioning tool 40 is configured to keep the pole faces 22, 24 in an accurate radial position and to assist in eliminating possible movement of the pole faces 22, 24 due to magnetic forces during removal of he magnetic blocks 26, 28. By lifting the pole faces 22, 24 and creating the gaps 42, 44, the pole face positioning tool 40 allows the magnet disassembly process to proceed without interference from the pole faces 22, 24. The width of gaps 42, 44 (i.e., the distance or height the pole faces 22, 24 are raised from the permanent magnets 16, 18) may be adjusted using pole face positioning tool 40.

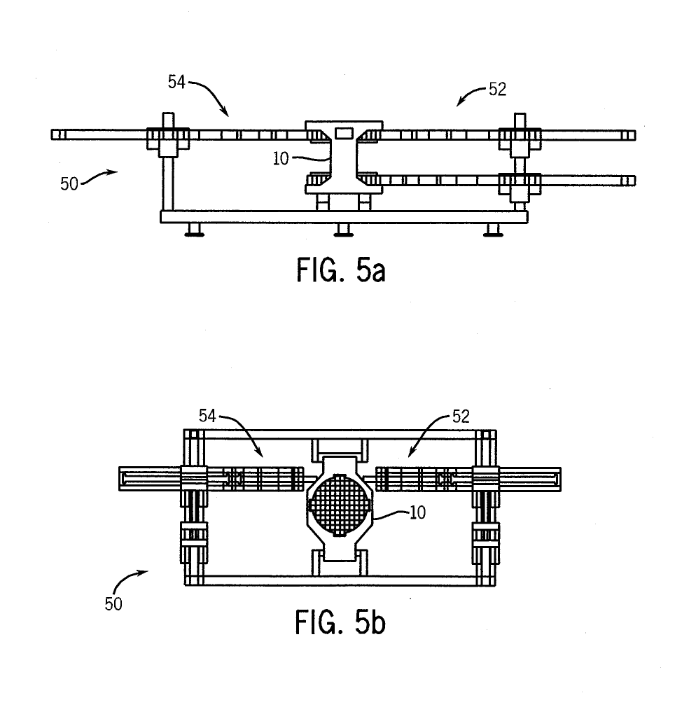

Once the pole faces 22, 24 are lifted from the permanent magnets 16, 18, respectively, the magnetic blocks 26, 28 of each permanent magnet 16, 18 are removed from the magnetic field generator 10 using a magnetic block pusher device and non-magnetic spacers as described further below. FIGS. 5a and 5b illustrate an exemplary magnetic block pusher tool in accordance with an embodiment. FIG. 5a shows a side view of an exemplary magnetic block pusher tool 50 and FIG. 5b shows a top view of the exemplary magnetic block pusher tool 50. The magnetic field generator 10 is placed in proximity of the magnetic block pusher tool 50. The magnetic block pusher tool 50 comprises a front pusher head 52 and a rear pusher head 54 which are configured to move in a plurality of directions including left/right directions, front/rear directions and up/down directions. Magnetic block pusher tool 50 may be aligned with each of the permanent magnets in the magnetic field generator 10 to facilitate sliding non-magnetic spacers into the permanent magnet layout to push the magnetic blocks out of the permanent magnet. Front pusher head 52 and rear pusher head 54 may be configured as cylinders in which magnetic blocks and/or a non-magnetic spacer may be placed and through which the magnetic blocks and/or non-magnetic spacer may be pushed or slid. Accordingly, front pusher head 52 has dimensions configured to accommodate a non-magnetic spacer and to allow the non-magnetic spacer to be pushed and slid through the front pusher head 52. Rear pusher head 54 has dimensions configured to accommodate a magnetic block or blocks and to allow the magnetic blocks to be pushed or slid into and through the rear pusher head 54.

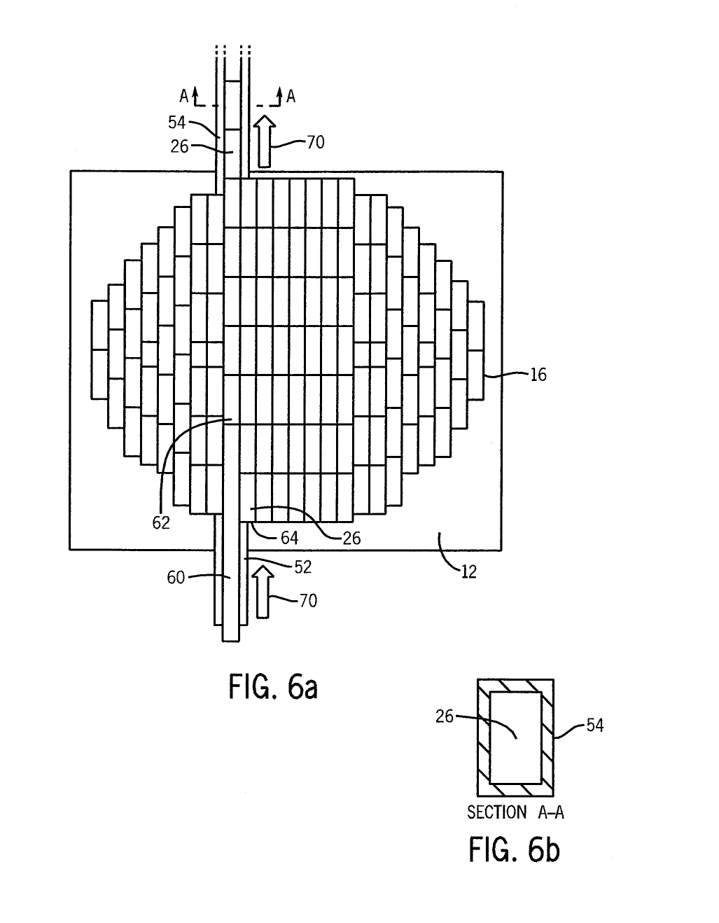

In one embodiment, any parts used to hold the magnetic blocks of the permanent magnet in place, such as block retainers, are removed from the permanent magnet layout on the yoke plate. The position of front pusher head 52 and rear pusher head 54 is adjusted so that both pusher heads 52, 54 are aligned with a row of magnetic blocks in one of the permanent magnets of the magnetic field generator as shown in FIG. 6a. For example, as shown in FIG. 6a, the front pusher head 52 and the rear pusher head 54 may be aligned with a row 62 of magnetic blocks 26 of the first permanent magnet 16 (also shown in FIG. 1) of the magnetic field generator. A non-magnetic spacer 60 is placed in the front pusher head 52. Preferably, non-magnetic spacer 60 is made of a non-magnetic material such as aluminum, stainless steel, plastics such as PVC (polyvinyl chloride) and PE (poly ethelene), etc. Non-magnetic spacer 60 may be fabricated to a selected length. For example, in one embodiment, non-magnetic spacer 60 has a length approximately as long as a particular row of magnetic blocks 26 in the permanent magnet layout and a single non-magnetic spacer 60 may be used to replace the magnetic blocks 26 in the particular row of the permanent magnet. Alternatively, non-magnetic spacer 60 may have a length that is less than the length of a particular row of magnetic blocks 26 and more than one spacer 60 may be used to replace the magnetic blocks 26 in the particular row of the permanent magnet. Preferably, non-magnetic spacer 60 also has width and height dimensions similar to a magnetic block in the permanent magnet.

The non-magnetic spacer 60 in the front pusher head 52 is pushed into the row 62 of magnetic blocks 26 using the front pusher head 52 and the non-magnetic spacer 60 is used to move the magnetic blocks 26 out of the permanent magnet 16 into the rear pusher head 54. The magnetic blocks 26 slide into the rear pusher head 54 as the spacer 60 is pushed into the row 62. Accordingly, the spacer 60 replaces the magnetic blocks 26 in the row 62 as it is used to push out the magnetic blocks 26. The non-magnetic spacer 60 is left in the permanent magnet layout and prevents the remaining magnetic blocks 26 from tilting. The movement of the spacer 60 and magnetic blocks 26 (the direction of which is shown by arrows 70) are guided by and limited by the front pusher head 52 and the rear pusher head 54. FIG. 6b shows a magnetic block 26 located within a pusher head, for example, rear pusher head 54. As mentioned, each pusher head 52, 54 has dimensions configured to accommodate a spacer 60 or magnetic block 26 and to allow the spacer 60 or magnetic block 26 to slide into and through the pusher heads 52,54.

Returning to FIG. 6a, as each magnet block 26 in row 62 slides into the rear pusher head 54, the magnetic repelling forces generated between two adjacent magnetic blocks 26 will dispatch the magnetic block 26 into the rear pusher head 54. Once a magnetic block 26 is in the rear pusher head 54, the magnetic block 26 may be removed from the rear pusher head 54 to be demagnetized. Magnet blocks 26 may be demagnetized using known methods in the art such as demagnetizing equipment or an oven.

After a first magnet block 26 is pushed into the rear pusher head 54 and removed from the rear pusher head 54, spacer 60 is again pushed into the row 62 to slide the next magnetic block 26 out of the permanent magnet into the rear pusher head 54 where the magnetic block 26 may be removed and then demagnetized. Spacer 60 is repeatedly pushed into row 62 until all of the magnetic blocks 26 in row 62 are pushed out and replaced by the non-magnetic spacer 60. As mentioned above, one non-magnetic spacer 60 may be used to replace the entire row 62 of magnetic blocks 26 or more than one non-magnetic spacer 60 may be used in the row 62. Once an entire row 62 of magnetic blocks 26 is pushed out and replaced by at least one spacer 60, the front pusher head 52 and the rear pusher head 54 are repositioned to align with another row 64 of magnetic blocks 26 in the permanent magnet 16. Another non-magnetic spacer or spacers 60 is placed in the front pusher head 52 and pushed into the row 64 of magnetic blocks 26 until the magnetic blocks 26 in the row 64 are pushed out of the permanent magnet and removed. This process is repeated for each subsequent row of magnetic blocks 26 in the permanent magnet 16 until each row of magnetic blocks 26 is replaced with a spacer or spacers 60 and the magnetic blocks 26 are removed from the permanent magnet 16. The permanent magnet layout will then be comprised of non-magnetic spacers 60. As mentioned above, the magnetic blocks 26 removed from the permanent magnet may be demagnetized using known methods.

Once the magnetic blocks 26 of the first permanent magnet 16 are replaced by spacers 60, the front pusher head 52 and the rear pusher head 54 are moved and aligned with a row of magnetic blocks in the second permanent magnet 18 (shown in FIG. 4) of the magnetic field generator 10 (shown in FIG. 4). The process described above is repeated to remove the magnetic blocks of the second permanent magnet 18 using non-magnetic spacers 60. Accordingly, the magnetic blocks of the second permanent magnet 18 are also replaced with spacers 60 so that the permanent magnet layout is comprised of non-magnetic spacers 60. Once the magnetic blocks of each permanent magnet in the magnetic field generator are replaced with spacers 60, the spacers 60 may be removed from the yoke plates 12, 14 (shown in FIG. 4) of the magnetic field generator 10 (shown in FIG. 4). The pole faces 22, 24 may then be lowered using the pole face positioning tool 40. The pole faces 22, 24 and pole face positioning tool 40 are removed from the magnetic field generator 10. In one embodiment, the yoke plates, pole faces and demagnetized magnetic blocks may be recycled or reused.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. The order or sequence of any process or method steps may be varied or re-sequenced according to alternative embodiments.

Many other changes and modifications may be made to the present invention without departing from the spirit thereof. The scope of these and other changes will become apparent from the appended claims.

1. A method for disassembling a permanent magnet of a magnetic field generator, the permanent magnet comprised of a plurality of magnetic blocks having a layout, the method comprising:
pushing at least one non-magnetic spacer into the layout of the plurality of magnetic blocks;
displacing at least one magnetic block with the at least one non-magnetic spacer until the at least one magnetic block is pushed out of the layout of the plurality of magnetic blocks; and
when the at least one magnetic block is pushed out of the layout, removing the magnetic block from the magnetic field generator.

2. A method according to claim 1, further comprising:
repeating the steps of displacing and removing until each of the plurality of magnetic blocks is replaced with at least one non-magnetic spacer.

3. A method according to claim 1, wherein the layout of the plurality of magnetic blocks comprises at least one row of magnetic blocks.

4. A method according to claim 3, further comprising:
repeating the steps of displacing and removing until each magnetic block in the at least one row is replaced with at least one non-magnetic spacer.

5. A method according to claim 3, wherein the layout of the plurality of magnetic blocks comprises a plurality of rows of magnetic blocks, the method further comprising:
repeating the steps of displacing and removing until each row of magnetic blocks is replaced by at least one non-magnetic spacer.

6. A method according to claim 1, further comprising:
demagnetizing the removed magnetic block.

7. A method according to claim 1, wherein the at least one non-magnetic spacer is pushed into the layout of the plurality of magnetic blocks using a magnetic block pusher tool comprising a first pusher head.

8. A method according to claim 7, further comprising before the step of pushing:
aligning the front pusher head with at least one magnetic block in the layout.

9. A method according to claim 7, wherein the magnetic block pusher tool further comprises a rear pusher head.

10. A method according to claim 9, further comprising:
pushing the at least one magnetic block out of the layout into the rear pusher head; and
removing the at least one magnetic block from the rear pusher head.

11. A method for disassembling a magnetic field generator comprising a first yoke plate, a first permanent magnet comprised of a plurality of magnetic blocks having a layout and positioned on the yoke plate and a first pole face positioned on the first permanent magnet, the method comprising:
lifting the first pole face away from the first permanent magnet to create a gap between the first pole face and the first permanent magnet;
pushing at least one non-magnetic spacer into the layout of the plurality of magnetic blocks;
displacing at least one magnetic block with the at least one non-magnetic spacer until the at least one magnetic block is pushed out of the layout of the plurality of magnetic blocks; and
when the at least one magnetic block is pushed out of the layout, removing the magnetic block from the magnetic field generator.

12. A method according to claim 11, wherein the layout of the plurality of magnetic blocks comprises at least a first row of magnetic blocks and a second row of magnetic blocks.

13. A method according to claim 12, wherein pushing at least one non-magnetic spacer into the layout of the plurality of magnetic blocks comprises pushing a first non-magnetic spacer into the first row of magnetic blocks

14. A method according to claim 13, further comprising:
repeating the steps of displacing and removing until each magnetic block in the first row of magnetic blocks is replaced with the first non-magnetic spacer.

15. A method according to claim 14, further comprising:
pushing a second non-magnetic spacer into the second row of magnetic blocks;
displacing at least one magnetic block in the second row with the second non-magnetic spacer until the at least one magnetic block is pushed out of the layout of the plurality of magnetic blocks; and
when the at least one magnetic block is pushed out of the layout, removing the magnetic block from the magnetic field generator.

16. A method according to claim 15, further comprising:
repeating the steps of displacing at least one magnetic block in the second row and removing the magnetic block from the magnetic field generator until each magnetic block in the second row of magnetic blocks is replaced with the first non-magnetic spacer.

17. A method according to claim 11, wherein the at least one non-magnetic spacer is pushed into the layout of the plurality of magnetic blocks using a magnetic block pusher tool comprising a first pusher head.

18. A method according to claim 17, further comprising before the step of pushing:
aligning the front pusher head with at least one magnetic block in the layout.

19. A method according to claim 17, wherein the magnetic block pusher tool further comprises a rear pusher head.

20. A method according to claim 19, further comprising:
pushing the at least one magnetic block out of the layout into the rear pusher head; and
removing the at least one magnetic block from the rear pusher head.

21. A method according to claim 11, further comprising demagnetizing the removed magnetic block.
